(19) United States
(12) Patent Application Publication
(10) Pub. No.: US 2022/0107498 A1
(43) Pub. Date: Apr. 7, 2022

(54) SMART GLASSES HAVING EXPANDING EYEBOX

(71) Applicant: Acer Incorporated, New Taipei City (TW)

(72) Inventors: Tsung-Wei Tu, New Taipei City (TW); Shih-Ting Huang, New Taipei City (TW); Yi-Jung Chiu, New Taipei City (TW); Yen-Hsien Li, New Taipei City (TW)

(73) Assignee: Acer Incorporated, New Taipei City (TW)

(21) Appl. No.: 17/110,334

(22) Filed: Dec. 3, 2020

(30) Foreign Application Priority Data
Oct. 5, 2020 (TW) 109134428

(51) Int. Cl. G02B 27/01; G02C 7/12

(52) U.S. Cl. CPC G02B 27/0172; G02B 27/0176; G02B 2027/013; G02B 2027/0178; G02B 2027/0125; G02C 7/12

(57) ABSTRACT

The invention provides smart glasses having expanding eyebox, which includes a projector and at least one beam translation module. The projector provides an image beam, which is polarized. The at least one beam translation module is disposed on a path of the image beam, and includes an adjustable liquid crystal panel and a birefringent crystal plate. The adjustable liquid crystal panel is disposed on the path of the image beam and configured to adjust an amount of phase retardation of the image beam. The birefringent crystal plate is disposed on a path of the image beam from the adjustable liquid crystal panel. After the amount of phase retardation of the image beam is adjusted through the adjustable liquid crystal panel, a translation in a direction parallel to a beam-emitting surface of the birefringent crystal plate occurs on the image beam exited from the birefringent crystal plate.

### CROSS-REFERENCE TO RELATED APPLICATION

This application claims the priority benefit of Taiwan application no. 109134428, filed on Oct. 5, 2020. The entirety of the above-mentioned patent application is hereby incorporated by reference herein and made a part of this specification.

### TECHNICAL FIELD

The invention relates to smart glasses, and more particularly, to smart glasses having expanding eyebox.

### BACKGROUND

With the advancement of display technology, augmented reality display technology and virtual reality display technology have gradually become popular and are widely used in people's lives. This type of display technology belongs to a visual optical system. In the field of visual optics, a space where the eye can observe an image or the space where the eye can observe a clear image is called the eyebox. When a visual direction or position of the eye of the user exceeds a range of the eye box, the user cannot see the image, or cannot see the clear image.

In practical applications, since different users have different eye pupil distances, if the eye box of the visual optical system is fixed and cannot be expanded, it will inevitably cause restrictions on the users. Therefore, the development of a visual optical system that can expand the size of the eye box has become a research direction. In the existing smart glasses, a position or an orientation of an optical element is controlled mechanically or electromechanically to change an angle of an image beam incident on a diffraction optical element (DOE) on a glasses lens to further expand the eye box. However, mechanical or electromechanical control methods increase the complexity of the adjustment mechanism.

### SUMMARY

The invention provides smart glasses having expanding eye box, which can expand the size of the eye box and adapt to different users.

According to an embodiment of the invention, smart glasses having expanding eyebox include a projector and at least one beam translation module. The projector provides an image beam, which is polarized. The at least one beam translation module is disposed on a path of the image beam, and includes an adjustable liquid crystal panel and a birefringent crystal plate. The adjustable liquid crystal panel is disposed on the path of the image beam and configured to adjust an amount of phase retardation of the image beam. The birefringent crystal plate is disposed on a path of the image beam from the adjustable liquid crystal panel. After the amount of phase retardation of the image beam is adjusted through the adjustable liquid crystal panel, a translation in a direction parallel to a beam-emitting surface of the birefringent crystal plate occurs on the image beam exited from the birefringent crystal plate.

Based on the above, according to the smart glasses expanding eye box provided by the embodiments of the invention, the adjustable liquid crystal panel is used to make the phase retardation of the image beam adjustable and accordingly make the polarization direction of the image beam adjustable. Further, in combination with the birefringent crystal plate, the projection position of the image beam can be adjusted to achieve the function of expanding eye box.

To make the aforementioned more comprehensible, several embodiments accompanied with drawings are described in detail as follows.

### BRIEF DESCRIPTION OF THE DRAWINGS

FIG. 1 illustrates a top view of smart glasses according to an embodiment of the invention.

FIG. 2A illustrates a top view of a projector and a beam translation module of smart glasses according to an embodiment of the invention.

FIG. 2B illustrates a top view of two beam translation modules in FIG. 2A.

FIG. 3 illustrates an optical mechanism of a birefringent crystal plate.

FIG. 4A is a schematic diagram illustrating the optical mechanism of a polarizer and one beam translation module in FIG. 2A according to an embodiment of the invention.

FIG. 4B is a schematic diagram illustrating a projection state of an image beam under the optical architecture of FIG. 4A.

FIG. 5A and FIG. 5B are schematic diagrams illustrating the optical mechanism of a polarizer and two beam translation modules in FIG. 2A according to an embodiment of the invention.

FIG. 5C is a schematic diagram illustrating a projection state of an image beam under the optical architecture of FIG. 5A and FIG. 5B.

FIG. 5D is a schematic diagram illustrating the optical mechanism of the polarizer and two beam translation modules in FIG. 2A according to an embodiment of the invention.

FIG. 6 illustrates a projection state of an image beam of smart glasses according to an embodiment of the invention.

### DETAILED DESCRIPTION

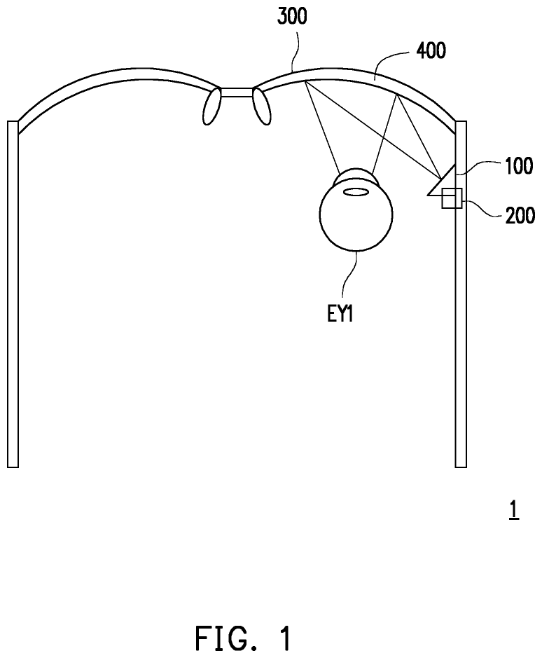

Referring to FIG. 1, FIG. 1 illustrates a top view of smart glasses according to an embodiment of the invention. Smart glasses 1 include at least one beam translation module 100, a projector 200, a lens 300 and a diffraction optical element 400. The diffraction optical element 400 is disposed on the lens 300. The projector 200 provides an image beam, which is polarized. The at least one beam translation module 100 is disposed on a path of the image beam. The image beam is reflected by the diffraction optical element 400 to enter an eye EY1 of a user.

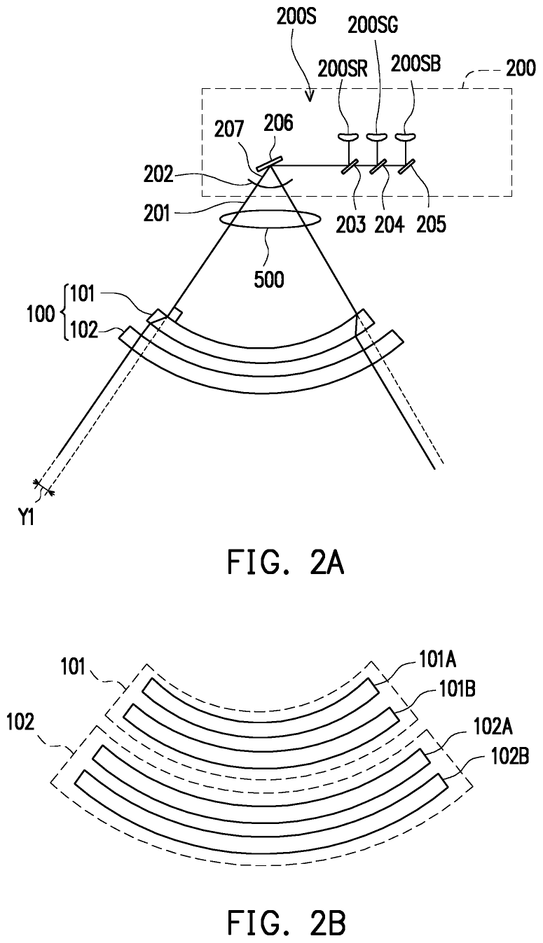

Referring to FIG. 2A and FIG. 2B, FIG. 2A illustrates a top view of a projector and a beam translation module of smart glasses according to an embodiment of the invention, and FIG. 2B illustrates a top view of two beam translation modules in FIG. 2A. In this embodiment, two beam translation modules 101 and 102 are disposed and can be regarded as a possible implementation of the at least one beam translation module 100 in the embodiment shown in FIG. 1, but the invention is not limited thereto. In some embodiments of the invention, the at least one beam translation module 100 can be implemented by one, three, four, or any other number of the beam translation modules.

The projector 200 provides an image beam 201, which is polarized. The projector 200 may be specifically implemented by a laser projection display. In this embodiment, the projector 200 includes an image source 200S and a polarizer 202. The image source 200S includes a red laser diode 200SR, a green laser diode 200SG, a blue laser diode 200SB, beam splitters 203, 204 and 205, and a scanning mirror 206. The image source 200S is configured to emit an original image beam 207. Specifically, the red laser diode 200SR, the green laser diode 200SG and the blue laser diode 200SB emit red laser light, green laser light and blue laser light, respectively. The red laser light, the green laser light and the blue laser light are combined by the beam splitters 203, 204 and 205 to form the original image beam 207. The original image beam 207 is emitted from the projector 200 in different directions by the scanning mirror 206. The intensities of the red laser light, the green laser light and the blue laser light corresponding to the original image beam 207 emitted in different directions are determined according to an image to be projected by the projector 200.

The polarizer 202 is disposed on a path of the original image beam 207 to convert the original image beam 207 into the image beam 201, which is polarized. The polarizer 202 is an arc-shaped polarizer, such as a linear polarizer. The original image beam 207 emitted in different directions by the scanning of the scanning mirror 206 is perpendicularly incident on the polarizer 202. The original image beam 207 is transmitted through the polarizer 202 to form the image beam 201. The image beam 201 is a linearly polarized beam, but the invention is not limited thereto. In an embodiment of the invention, the original image beam 207 is not transmitted through the polarizer but directly used as the image beam 201.

In this embodiment, a lens 500 is disposed on a path of the image beam 201 to further optimize an imaging quality of the image beam 201, but the invention is not limited thereto. In other embodiments of the invention, a plurality of lenses may be used to optimize the imaging quality of the image beam 201. The surface shapes, materials, refractive powers, thicknesses, etc. of the plurality of lenses may be different from each other. In another embodiment of the invention, the lens 500 may not be disposed.

The beam translation modules 101 and 102 are sequentially disposed on the path of the image beam 201. The beam translation module 101 includes an adjustable liquid crystal panel 101A and a birefringent crystal plate 101B. The beam translation module 102 includes an adjustable liquid crystal panel 102A and a birefringent crystal plate 102B. The polarized image beam 201 in FIG. 2A is sequentially transmitted through the adjustable liquid crystal panel 101A, the birefringent crystal plate 101B, the adjustable crystal panel 102A and the birefringent crystal plate 102B. It should be noted that with the scanning of the scanning mirror 206, the image beam 201 emitted in different directions is perpendicularly incident on different positions of the arc-shaped adjustable liquid crystal panel 101A, perpendicularly incident on different positions of the arc-shaped birefringent crystal plate 101B, perpendicularly incident on different positions of the arc-shaped adjustable liquid crystal panel 102A, and perpendicularly incident on different positions of the arc-shaped birefringent crystal plate 102B.

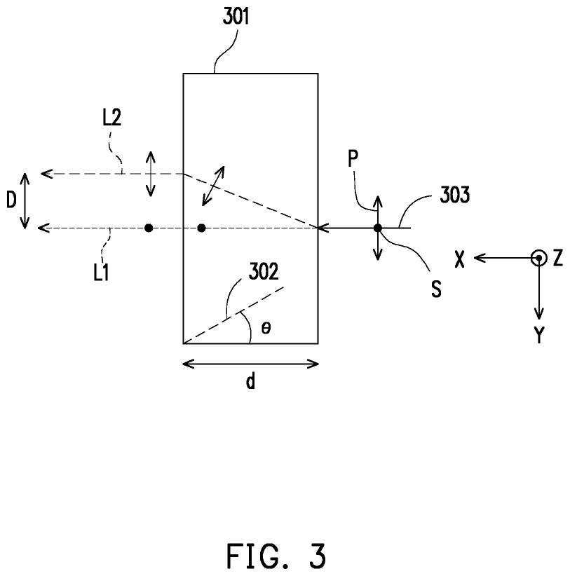

After being transmitted through the adjustable liquid crystal panel 101A, the image beam 201 has a phase retardation. By properly setting an orientation of an optical axis of crystal of the birefringent crystal plate 101B, a translation in a direction parallel to a beam-emitting surface of the birefringent crystal plate 101B can occur on the image beam 201 exited from the birefringent crystal plate 101B. Similarly, after being exited from the birefringent crystal plate 101B and transmitted through the adjustable liquid crystal panel 102A and the image beam 201 also has the phase retardation. By properly setting an orientation of an optical axis of crystal of the birefringent crystal plate 102B, a translation in a direction parallel to a beam-emitting surface of the birefringent crystal plate 102B occurs on the image beam 201 exited from the birefringent crystal plate 102B. The specific details of the orientation of the optical axis of crystal of each of the birefringent crystal plates 101B and 102B and the translation of the image beam 201 will be described in detail in the description of FIG. 3 to FIG. 5C below.

According to an embodiment of the invention, a controller may be electrically connected to the adjustable liquid crystal panels 101A and 102A to control operations of the adjustable liquid crystal panels 101A and 102A and accordingly control the translation of the image beam 201. Specifically, by controlling the orientations of liquid crystals in the adjustable liquid crystal panels 101A and 102A, a polarization state of the image beam 201 transmitted through the adjustable liquid crystal panels 101A and 102A may be controlled, so as to further control whether to the image beam 201 is translated through the birefringent crystal plates 101B and 102B. According to an embodiment of the invention, by controlling the controller connected to the adjustable liquid crystal panels 101A and 102A, the image beam 201 incident on the birefringent crystal plate 101B is not translated in the direction parallel to the beam-emitting surface of the birefringent crystal plate 102B after exited from the birefringent crystal plate 101B; however, the image beam 201 incident on the birefringent crystal plate 102B is translated in the direction parallel to the beam-emitting surface of the birefringent crystal plate 102B after exited from the birefringent crystal plate 102B. According to another embodiment of the invention, by controlling the controller connected to the adjustable liquid crystal panels 101A and 102A, the image beam 201 incident on the birefringent crystal plate 101B is translated in the direction parallel to the beam-emitting surface of the birefringent crystal plate 101B after exited from the birefringent crystal plate 101B; however, the image beam 201 incident on the birefringent crystal plate 102B is not translated in the direction parallel to the beam-emitting surface of the birefringent crystal plate 102B after exited from the birefringent crystal plate 102B. According to yet another embodiment of the invention, by controlling the controller connected to the adjustable liquid crystal panels 101A and 102A, the image beam 201 incident on the birefringent crystal plate 101B is translated in the direction parallel to the beam-emitting surface of the birefringent crystal plate 101B after exited from the birefringent crystal plate 101B; and the image beam 201 incident on the birefringent crystal plate 102B is translated in the direction parallel to the beam-emitting surface of the birefringent crystal plate 102B after exited from the birefringent crystal plate 102B.

According to the above description of FIG. 1, FIG. 2A and FIG. 2B, the beam translation modules 101 and 102 are used as the possible implementation of the at least one beam translation module 100 in the embodiment shown in FIG. 1. The image beam 201 can be translated by the beam translation modules 101 and 102, respectively (e.g., as shown in FIG. 2A, a translation with a translation amount Y1 is generated by the beam translation module 101). Accordingly, the image beam 201 can be incident on different positions of the diffraction optical element 400 in FIG. 1 to expand the eyebox of the smart glasses 1.

Referring to FIG. 3, FIG. 3 illustrates an optical mechanism of a birefringent crystal plate. A birefringent crystal plate 301 has an optical axis of crystal 302. A path of a beam 303 incident on the birefringent crystal plate 301 is in the same reference plane the optical axis of crystal 302 (i.e., the XY plane in FIG. 3) before incident on the birefringent crystal plate 301, and has an included angle (180° −θ) between the optical axis of crystal 302 and the X axis along the X direction. A thickness of the birefringent crystal plate 301 in the X direction is d. When the beam 303 of any polarization state is incident on the birefringent crystal plate 301, since an incident direction of the beam 303 is not parallel to the optical axis of crystal 302, the beam 303 is split into an ordinary beam L1 and an extraordinary beam L2 respectively traveling in different directions. Among them, the ordinary beam L1 has an S polarization state perpendicular to the reference plane, and the extraordinary beam L2 has a P polarization state parallel to the reference plane. The extraordinary beam L2 exited from the birefringent crystal plate 301 and the ordinary beam L1 exited from the birefringent crystal plate 301 have a translation amount D in the Y direction, and D satisfies the relational expressions: D=d×tan α (Formula 1) and

$$cot ( α + 45 ° ) = \frac{{n}_{e}^{2}}{{n}_{o}^{2}} cotθ . \qquad ( Formula 2 )$$

α is an included angle between the ordinary beam L1 and the extraordinary beam L2 in the birefringent crystal plate 301, and nₑ and nₒ are an extraordinary refractive index and an ordinary refractive index of the birefringent crystal plate 301, respectively. According to Formula 1 and Formula 2, it can be known that for different birefringent crystal plates of the same material and the same thickness, an amount of translation between the extraordinary beam L2 and the ordinary beam L1 merely depends on the included angle between the incident beam 303 and the optical axis of crystal. Specifically, when the beam is transmitted through the birefringent crystal plate, the beam of the S polarization state is not translated, and the beam with of the P polarization state is translated.

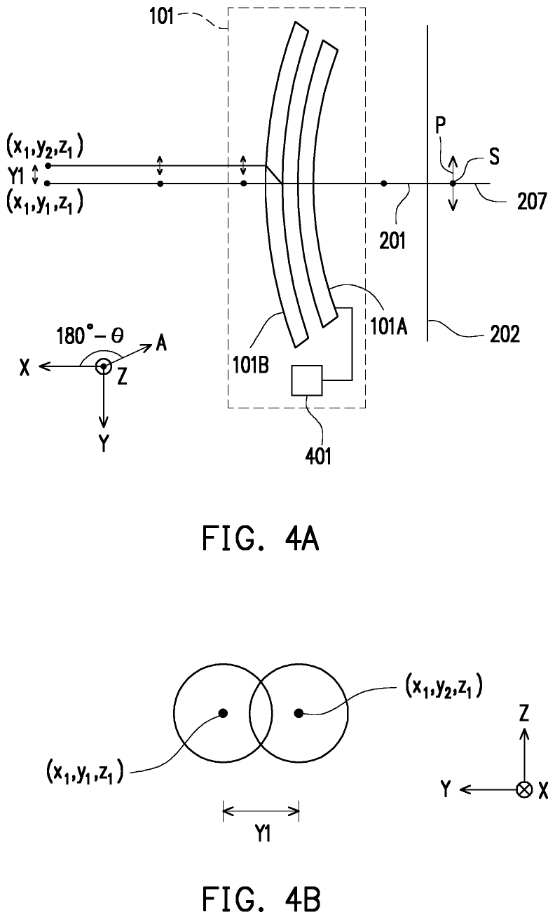

Referring to FIG. 2A, FIG. 2B and FIG. 4B together, FIG. 4A is a schematic diagram illustrating the optical mechanism of the polarizer 202 and one beam translation module 101 in FIG. 2A, and FIG. 4B is a schematic diagram illustrating a projection state of an image beam under the optical architecture of FIG. 4A. It should be noted that, as described in the above description of FIG. 2A and FIG. 2B, with the scanning of the scanning mirror 206, the image beam 201 emitted in different directions is perpendicularly incident on different positions of the arc-shaped adjustable liquid crystal panel 101A, and perpendicularly incident on different positions of the arc-shaped birefringent crystal plate 101B. In addition, the optical axis of crystal of the birefringent crystal plate 101B is not unidirectional. The orientation of the optical axis of crystal is different on the different position of the birefringent crystal plate 101B, and an included angle between the image beam 201 incident on the birefringent crystal plate 101B from a different position of the birefringent crystal plate 101B and the optical axis of crystal on that position is constant. As described above with respect to FIG. 3, when the beam is transmitted through the birefringent crystal plates of the same material and the same thickness, the amount of translation between the extraordinary beam and the ordinary beam depends merely on the included angle between the incident beam and the optical axis of crystal. Therefore, after the image beam 201 of the different direction in FIG. 2A is transmitted through the birefringent crystal plate 101B with uniform thickness, the amount of translation between the extraordinary beam and the ordinary beam is consistent. Due to the above consistency, for the convenience of understanding, in FIG. 4A, one image beam 201 generated after the original image beam 207 is transmitted through the polarizer 202 is used to represent optical performance of the image beams 21 from various directions in FIG. 2A.

In FIG. 4A, the adjustable liquid crystal panel 101A may include, for example, vertical alignment type liquid crystals, but the invention is not limited thereto. In other embodiments of the invention, the adjustable liquid crystal panel 101A may include one of twisted nematic (TN) mode liquid crystals, in-plane switching (IPS) mode liquid crystals and patterned vertical alignment (PVA) mode liquid crystals. The original image beam 207 is incident on the polarizer 202 along the X direction, and an included angle (180° −θ) is provided between an orientation A of an optical axis of crystal of the birefringent crystal plate 101B and the X axis on the XY plane.

When a controller 401 does not apply voltage to the adjustable liquid crystal panel 101A, long axes of the vertical alignment type liquid crystals therein are arranged along the X direction. After the original image beam 207 of any polarization state is transmitted through the polarizer 202, the image beam 201 of a linear polarization is formed, which is in the S polarization state. Since the long axes of liquid crystal molecules of the adjustable liquid crystal panel 101A are arranged along a direction parallel to the X axis, the image beam 201 does not have the phase retardation, but continue to exit from the adjustable liquid crystal panel 101A in the S polarization state. After being transmitted through the birefringent crystal plate 101B, the image beam 201 of the S polarization state does not have the translation and is projected at a position with coordinates (x₁,y₁,z₁), which is shown in the YZ plane shown in FIG. 4B.

In contrast, when the controller 401 applies voltage to the adjustable liquid crystal panel 101A, an included angle is provided between an arrangement direction of the long axes of the vertical alignment type liquid crystals inside the controller 401 and the X axis. The phase retardation will occur on the image beam 201 of the S polarization state incident on the adjustable liquid crystal panel 101A. With proper configuration, the image beam 201 can be emitted from the adjustable liquid crystal panel 101A in the P polarization state. In other words, the adjustable liquid crystal panel 101A causes the phase retardation of the image beam 201, so that a polarization direction of the image beam 201 changes from a direction parallel to the Z axis to a direction parallel to the Y axis. After being transmitted through the birefringent crystal plate 101B, the image beam 201 of the P polarization state is translated and projected at a position with coordinates (x₁,y₂,z₁), which is shown in the YZ plane shown in FIG. 4B. A distance between the position with coordinates (x₁,y₂,z₁) and the position with coordinates (x₁,y₁,z₁) is Y1=y₁−y₂. In other words, with the configuration of the adjustable liquid crystal panel 101A and the birefringent crystal plate 101B, the translation occurs on the image beam 201, and the translation amount is Y1. The magnitude of the translation amount Y1 is determined by the thickness, the extraordinary refractive index, the ordinary refractive index and the orientation of the optical axis of crystal of the birefringent crystal plate 101B as described above for Formula 1 and Formula 2.

Based on the above, it can be known that by arranging one beam translation module on the path of the image beam, the image beam can be translated in one direction on a projection surface to expand the eye box.

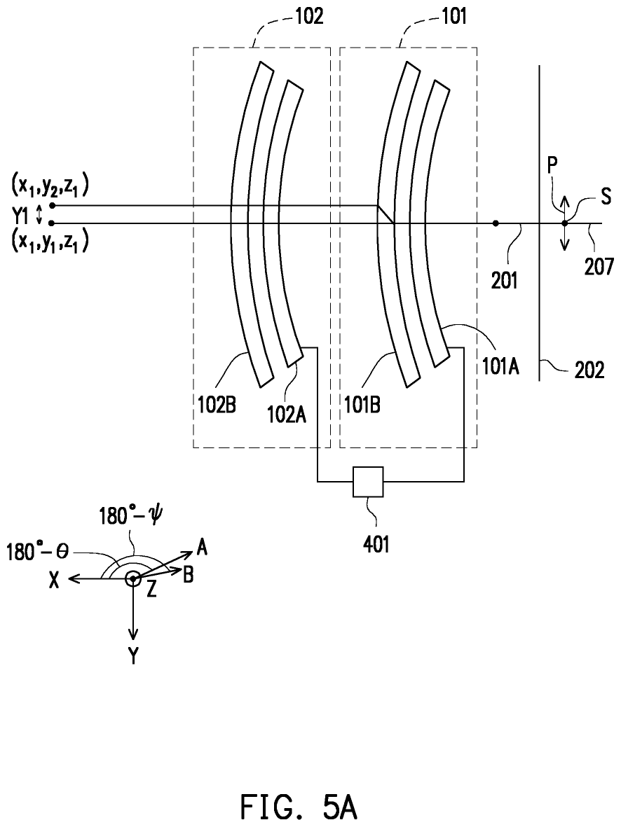

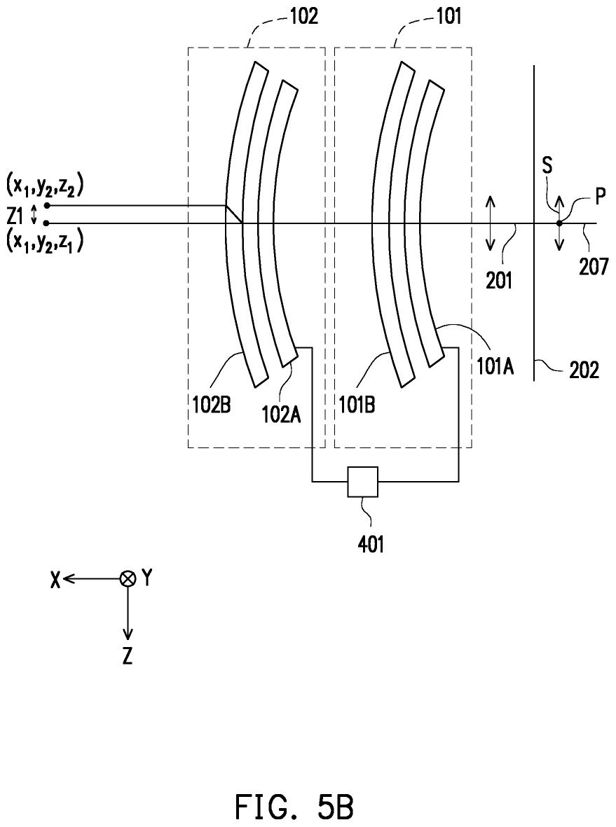

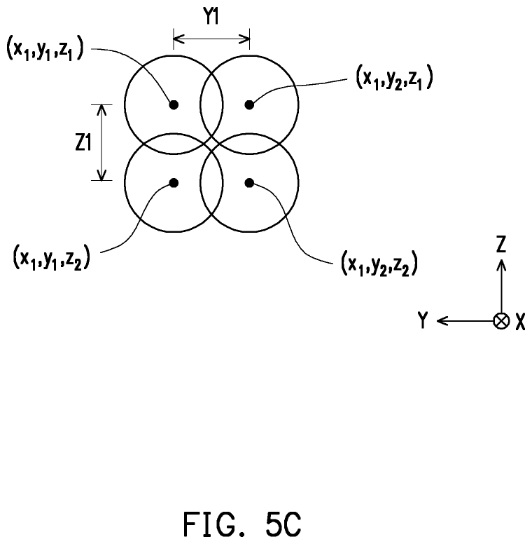

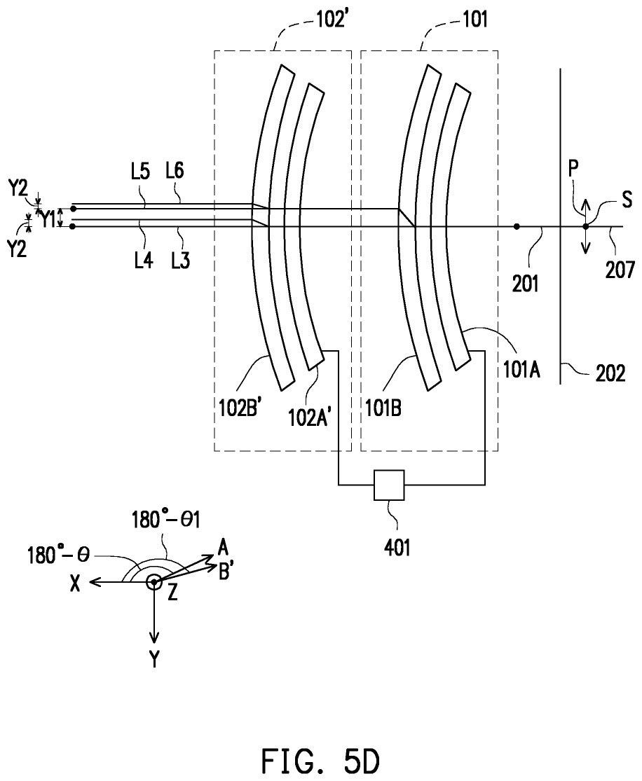

Referring to FIG. 5A, FIG. 5B and FIG. 5C, FIG. 5A and FIG. 5B are schematic diagrams illustrating the optical mechanism of the polarizer 202 and the two beam translation modules 101 and 102 in FIG. 2A according to an embodiment of the invention. FIG. 5A is drawn on the XY plane, and FIG. 5B is drawn on the XZ plane to clearly show the translation of the image beam in different directions. FIG. 5C is a schematic diagram illustrating a projection state of an image beam under the optical architecture of FIG. 5A (and FIG. 5B). For the purpose of clear description and avoid confusion, the following description will be made with reference to FIG. 5A and FIG. 5C first. It should be noted here that the configuration of elements in the right half of FIG. 5A (i.e., the polarizer 202 and the beam translation module 101) is the same as that of FIG. 4A, and optical characteristics of the original image beam 207 and the image beam 201 in the above-mentioned element and before and after being transmitted through the above-mentioned element are also the same as those shown in FIG. 4A and FIG. 4B. Therefore, the same reference numerals are used to denote the same elements, and the description of the same technical content is omitted. The omitted part of the description can refer to the description above, which is not repeated hereinafter.

In FIG. 5A, the beam translation module 102 including the adjustable liquid crystal panel 102A and the birefringent crystal plate 102B is disposed on a path of the image beam 201 exited from the beam translation module 101. The controller 401 is connected to the adjustable liquid crystal panel 101A to control the arrangement direction of the long axes of the vertical alignment type liquid crystals inside the adjustable liquid crystal panel 101A. When the controller 401 applies the same voltage to the adjustable liquid crystal panel 101A and the adjustable liquid crystal panel 102A, the phase retardations of the incident beam caused by the two adjustable liquid crystal panels are the same, but the invention is not limited thereto. In some embodiments of the invention, the adjustable liquid crystal panel 101A and the adjustable liquid crystal panel 102A can generate different phase retardations.

An included angle (180° −ψ) is provided between an orientation B of an optical axis of crystal of the birefringent crystal plate 102B and the X axis on the XZ plane. It should be particularly noted that the included angle (180° −ψ) is provided between the orientation A of the optical axis of crystal of the birefringent crystal plate 101B and the X axis on the XY plane. Since the orientations of the optical axis of crystals of the birefringent crystal plates 101B and 102B are different, the reference plane is the XY plane for the birefringent crystal plate 101B, and the reference plane is the XZ plane for the birefringent crystal plate 102B. Due to the difference in the reference planes, in the following description, the polarization states of the image beam 201 at different positions in FIG. 5A will be described explicitly with the polarization direction parallel to the Y axis or the polarization direction parallel to the Z axis instead of the S polarization state or the P polarization state, so as to avoid confusion. Specifically, if the polarization direction of the image beam 201 incident on the birefringent crystal plate 101B is parallel to the Y axis, the translation will occur in the Y direction due to the transmission of the birefringent crystal plate 101B. If the polarization direction of the image beam 201 incident on the birefringent crystal plate 101B is parallel to the Z axis, the translation will not occur. If the polarization direction of the image beam 201 incident on the birefringent crystal plate 102B is parallel to the Y axis, the translation will not occur. If the polarization direction of the image beam 201 incident on the birefringent crystal plate 102B is parallel to the Z axis, the translation will occur in the Z direction due to the transmission of the birefringent crystal plate 102B.

By selecting whether to apply voltage the adjustable liquid crystal panels 101A and 102A through the controller 401, there can be four situations in which the image beam 201 is projected at four different positions, as detailed below.

In the first situation, the adjustable liquid crystal panel 101A is not applied with voltage, and the adjustable liquid crystal panel 101A does not cause the phase retardation on the incident beam; the adjustable liquid crystal panel 102A is applied with voltage through the controller 401, and the adjustable liquid crystal panel 102A causes the phase retardation on the incident beam. The polarization direction of the image beam 201 exited from the polarizer 202 is parallel to the Z axis before incident on the adjustable liquid crystal panel 101A. Since the adjustable liquid crystal panel 101A does not cause the phase retardation, the polarization direction of the image beam 201 exited from the adjustable liquid crystal panel 101A is still parallel to the Z axis. After being transmitted through the birefringent crystal plate 101B, the translation does not occur on the image beam 201. The polarization direction of the image beam 201 incident on the adjustable liquid crystal panel 102A is parallel to the Z axis. Since the adjustable liquid crystal panel 102A will cause the phase retardation on the incident beam, the polarization direction of the image beam 201 exited from the adjustable liquid crystal panel 102A is parallel to the Y axis, and the translation does not occur after the image beam is transmitted through the birefringent crystal plate 102B. The image beam 201 will be projected at a position with coordinates (x₁,y₁,z₁), which is shown in the YZ plane shown in FIG. 5C.

In the second situation, the adjustable liquid crystal panel 101A is not applied with voltage, and the adjustable liquid crystal panel 101A does not cause the phase retardation on the incident beam; the adjustable liquid crystal panel 102A is not applied with voltage, and the adjustable liquid crystal panel 102A does not cause the phase retardation on the incident beam. The polarization direction of the image beam 201 exited from the polarizer 202 is parallel to the Z axis before incident on the adjustable liquid crystal panel 101A. Since the adjustable liquid crystal panel 101A does not cause the phase retardation, the polarization direction of the image beam 201 exited from the adjustable liquid crystal panel 101A is still parallel to the Z axis. After being transmitted through the birefringent crystal plate 101B, the translation does not occur on the image beam 201. The polarization direction of the image beam 201 incident on the adjustable liquid crystal panel 102A is parallel to the Z axis. Since the adjustable liquid crystal panel 102A will not cause the phase retardation on the incident beam, the polarization direction of the image beam 201 exited from the adjustable liquid crystal panel 102A is parallel to the Z axis, and the translation occurs after the image beam is transmitted through the birefringent crystal plate 102B (which is translated by a distance Z1 in the Z direction). The image beam 201 will be projected at a position with coordinates (x₁,y₁,z₂), which is shown in the YZ plane shown in FIG. 5C, where Z1=z₁−z₂.

In the third situation, the adjustable liquid crystal panel 101A is applied with voltage through the controller 401, and the adjustable liquid crystal panel 101A causes the phase retardation on the incident beam; the adjustable liquid crystal panel 102A is not applied with voltage, and the adjustable liquid crystal panel 102A does not cause the phase retardation on the incident beam. The polarization direction of the image beam 201 exited from the polarizer 202 is parallel to the Z axis before incident on the adjustable liquid crystal panel 101A. Since the adjustable liquid crystal panel 101A causes the phase retardation, the polarization direction of the image beam 201 exited from the adjustable liquid crystal panel 101A is parallel to the Y axis.

After being transmitted through the birefringent crystal plate 101B, the translation occurs on the image beam 201 (which is translated by the distance Y1 in the Y direction). The polarization direction of the image beam 201 incident on the adjustable liquid crystal panel 102A is parallel to the Y axis. Since the adjustable liquid crystal panel 102A will not cause the phase retardation on the incident beam, the polarization direction of the image beam 201 exited from the adjustable liquid crystal panel 102A is parallel to the Y axis, and the translation does not occur after the image beam is transmitted through the birefringent crystal plate 102B. The image beam 201 will be projected at a position with coordinates (x₁,y₂,z₁), which is shown in the YZ plane shown in FIG. 5C, where the translation amount Y1=z₁−z₂. The magnitude of Y1 is determined by the thickness, the extraordinary refractive index, the ordinary refractive index and the orientation of the optical axis of crystal of the birefringent crystal plate 101B as described above for Formula 1 and Formula 2.

In the fourth situation, the adjustable liquid crystal panel 101A is applied with voltage through the controller 401, and the adjustable liquid crystal panel 101A causes the phase retardation on the incident beam; the adjustable liquid crystal panel 102A is applied with voltage through the controller 401, and the adjustable liquid crystal panel 102A causes the phase retardation on the incident beam. The polarization direction of the image beam 201 exited from the polarizer 202 is parallel to the Z axis before incident on the adjustable liquid crystal panel 101A. Since the adjustable liquid crystal panel 101A causes the phase retardation, the polarization direction of the image beam 201 exited from the adjustable liquid crystal panel 101A is parallel to the Y axis. After being transmitted through the birefringent crystal plate 101B, the translation occurs on the image beam 201 (which is translated by the distance Y1 in the Y direction). The polarization direction of the image beam 201 incident on the adjustable liquid crystal panel 102A is parallel to the Y axis. Since the adjustable liquid crystal panel 102A will cause the phase retardation on the incident beam, the polarization direction of the image beam 201 exited from the adjustable liquid crystal panel 102A is parallel to the Z axis, and the translation occurs after the image beam is transmitted through the birefringent crystal plate 102B (which is translated by the distance Z1 in the Z direction). The image beam 201 will be projected at a position with coordinates (x₁,y₂,z₂), which is shown in the YZ plane shown in FIG. 5C, where the translation amount Y1=y₁−y₂ and the translation amount Z1=z₁−z₂. The magnitude of the translation amount Y1 is determined by the thickness, the extraordinary refractive index, the ordinary refractive index and the orientation of the optical axis of crystal of the birefringent crystal plate 101B as described above for Formula 1 and Formula 2. The magnitude of the translation amount Z1 is determined by the thickness, the extraordinary refractive index, the ordinary refractive index and the orientation of the optical axis of crystal of the birefringent crystal plate 102B as described above for Formula 1 and Formula 2.

In FIG. 5A, FIG. 5B and FIG. 5C, four possible coordinate positions (x₁,y₁,z₁), (x₁,y₁,z₂), (x₁,y₂,z₁) and (x₁,y₂,z₂) at which the image beam 201 can be projected are presented in the XY plane, the XZ plane and the YZ plane, respectively.

According to the above, it can be known that by disposing at least two beam translation modules on the path of the image beam and properly setting the orientation of the optical axis of crystal of each of the birefringent crystal plates in these beam translation modules, the translation can occur on the image beam in two intersecting directions on the projection surface to expand the eye box. The magnitude of the translation amount is determined by the thickness, the extraordinary refractive index, the ordinary refractive index and the orientation of the optical axis of crystal of the birefringent crystal plate. In other words, an expanding range of the eye box can be controlled by changing the thickness, the material, and the orientation of the optical axis of crystal of the configured one or more birefringent crystal plates.

Next, referring to FIG. 5D, FIG. 5D is a schematic diagram illustrating the optical mechanism of the polarizer 202 and two beam translation modules 101 and 102′ in FIG. 2A according to an embodiment of the invention. In this embodiment, an included angle (180° −θ) is provided between the orientation A of the optical axis of crystal of the birefringent crystal plate 101B and the X axis on the XY plane, and an included angle (180° −θ1) is also provided between an orientation B′ of an optical axis of crystal of the birefringent crystal plate 102B′ and the X axis on the XY plane. Here, θ1 is not equal to θ. However, the invention is not limited in this regard. According to another embodiment of the invention, θ1 is equal to θ.

In this embodiment, since the orientations of the optical axis of crystal of birefringent crystal plates 101B and 102B′ are all on the XY plane, when the polarization direction of the image beam transmitted through the birefringent crystal plate 101B is in the Y direction, the translation will occur on the image beam 201 in the Y direction; and, when the polarization direction of the image beam transmitted through the birefringent crystal plate 102B′ is in the Y direction, the translation will also occur on the image beam 201 in the Y direction. A translation amount caused by the birefringent crystal plate 101B is Y; a translation amount caused by the birefringent crystal plate 102B′ is Y2. The translation amount Y1 is greater than the translation amount Y2. However, the invention is not limited in this regard. In another embodiment of the invention, the translation amount Y1 is equal to the translation amount Y2. In another embodiment of the invention, the translation amount Y1 is less than the translation amount Y2.

By selecting whether to apply voltage to the adjustable liquid crystal panels 101A and 102A through the controller 401, the image beam 201 exited from the birefringent crystal panel 102B′ can have four situations, which are described as follows.

In the first situation, the adjustable liquid crystal panel 101A is not applied with voltage, and the adjustable liquid crystal panel 101A does not cause the phase retardation on the incident beam; the adjustable liquid crystal panel 102A is applied with voltage through the controller 401, and the adjustable liquid crystal panel 102A causes the phase retardation on the incident beam. The polarization direction of the image beam 201 exited from the polarizer 202 is parallel to the Z axis before incident on the adjustable liquid crystal panel 101A. Since the adjustable liquid crystal panel 101A does not cause the phase retardation, the polarization direction of the image beam 201 exited from the adjustable liquid crystal panel 101A is still parallel to the Z axis. After being transmitted through the birefringent crystal plate 101B, the translation does not occur on the image beam 201. The polarization direction of the image beam 201 incident on the adjustable liquid crystal panel 102A is parallel to the Z axis. Since the adjustable liquid crystal panel 102A will cause the phase retardation on the incident beam, the polarization direction of the image beam 201 exited from the adjustable liquid crystal panel 102A is parallel to the Y axis, and the translation occurs after the image beam is transmitted through the birefringent crystal plate 102B′, where the translation amount is Y2. In FIG. 5D, the image beam exited from the birefringent crystal plate 102B′ in the first situation is represented by a light beam L4.

In the second situation, the adjustable liquid crystal panel 101A is not applied with voltage, and the adjustable liquid crystal panel 101A does not cause the phase retardation on the incident beam; the adjustable liquid crystal panel 102A is not applied with voltage, and the adjustable liquid crystal panel 102A does not cause the phase retardation on the incident beam. The polarization direction of the image beam 201 exited from the polarizer 202 is parallel to the Z axis before incident on the adjustable liquid crystal panel 101A. Since the adjustable liquid crystal panel 101A does not cause the phase retardation, the polarization direction of the image beam 201 exited from the adjustable liquid crystal panel 101A is still parallel to the Z axis. After being transmitted through the birefringent crystal plate 101B, the translation does not occur on the image beam 201. The polarization direction of the image beam 201 incident on the adjustable liquid crystal panel 102A is parallel to the Z axis. Since the adjustable liquid crystal panel 102A will not cause the phase retardation on the incident beam, the polarization direction of the image beam 201 exited from the adjustable liquid crystal panel 102A is parallel to the Z axis, and the translation does not occur after the image beam is transmitted through the birefringent crystal plate 102B′. In FIG. 5D, the image beam exited from the birefringent crystal plate 102B′ in the second situation is represented by a light beam L3.

In the third situation, the adjustable liquid crystal panel 101A is applied with voltage through the controller 401, and the adjustable liquid crystal panel 101A causes the phase retardation on the incident beam; the adjustable liquid crystal panel 102A is not applied with voltage, and the adjustable liquid crystal panel 102A does not cause the phase retardation on the incident beam. The polarization direction of the image beam 201 exited from the polarizer 202 is parallel to the Z axis before incident on the adjustable liquid crystal panel 101A. Since the adjustable liquid crystal panel 101A causes the phase retardation, the polarization direction of the image beam 201 exited from the adjustable liquid crystal panel 101A is parallel to the Y axis. After being transmitted through the birefringent crystal plate 101B, the translation occurs on the image beam 201 (which is translated by the distance Y1 in the Y direction). The polarization direction of the image beam 201 incident on the adjustable liquid crystal panel 102A is parallel to the Y axis. Since the adjustable liquid crystal panel 102A will not cause the phase retardation on the incident beam, the polarization direction of the image beam 201 exited from the adjustable liquid crystal panel 102A is parallel to the Y axis, and the translation occurs after the image beam is transmitted through the birefringent crystal plate 102B′ (which is translated by the distance Y2 in the Y direction). In FIG. 5D, the image beam exited from the birefringent crystal plate 102B′ in the third situation is represented by a light beam L6.

In the fourth situation, the adjustable liquid crystal panel 101A is applied with voltage through the controller 401, and the adjustable liquid crystal panel 101A causes the phase retardation on the incident beam; the adjustable liquid crystal panel 102A is applied with voltage through the controller 401, and the adjustable liquid crystal panel 102A causes the phase retardation on the incident beam. The polarization direction of the image beam 201 exited from the polarizer 202 is parallel to the Z axis before incident on the adjustable liquid crystal panel 101A. Since the adjustable liquid crystal panel 101A causes the phase retardation, the polarization direction of the image beam 201 exited from the adjustable liquid crystal panel 101A is parallel to the Y axis. After being transmitted through the birefringent crystal plate 101B, the translation occurs on the image beam 201 (which is translated by the distance Y1 in the Y direction). The polarization direction of the image beam 201 incident on the adjustable liquid crystal panel 102A is parallel to the Y axis. Since the adjustable liquid crystal panel 102A will cause the phase retardation on the incident beam, the polarization direction of the image beam 201 exited from the adjustable liquid crystal panel 102A is parallel to the Z axis, and the translation does not occur after the image beam is transmitted through the birefringent crystal plate 102B′. In FIG. 5D, the image beam exited from the birefringent crystal plate 102B′ in the fourth situation is represented by a light beam L5.

According to the above, it can be known that by disposing at least two beam translation modules on the path of the image beam and properly setting the orientation of the optical axis of crystal of each of the birefringent crystal plates in these beam translation modules, multiple translations can occur on the image beam in one direction on the projection surface to expand the eye box. The magnitude of the translation amount is determined by the thickness, the extraordinary refractive index, the ordinary refractive index and the orientation of the optical axis of crystal of the birefringent crystal plate. In other words, an expanding range of the eye box can be controlled by changing the thickness, the material, and the orientation of the optical axis of crystal of the configured one or more birefringent crystal plates.

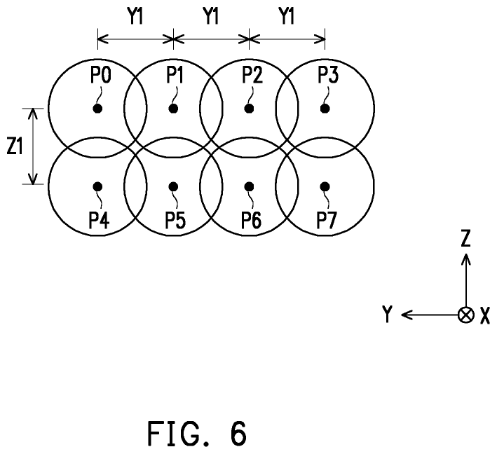

Referring to FIG. 6, FIG. 6 illustrates a projection state of an image beam of smart glasses according to an embodiment of the invention. By disposing multiple beam translation modules to translate a projection position of the image beam, the eye box is expanded. Specifically, for example, three beam translation modules 101 can be disposed to translate the projection position of the image beam in the Y direction, so that the image beam can be translated from an original projection position P0 to one of positions P1, P2 and P3. For example, three beam translation modules 101 and one beam translation module 102 can be disposed to translate the projection position of the image beam in the Y and Z directions, so that the image beam can be translated from the original projection position P0 to one of positions P1, P2, P3, P4, P5, P6 and P7.

In an embodiment, the controller is, for example, a central processing unit (CPU), a microprocessor, a digital signal processor (DSP), a programmable controller, a programmable logic device (PLD) or other similar devices or a combination of these devices, which is not particularly limited by the invention. Further, in an embodiment, various functions of the controller may be implemented as a plurality of program codes. These program codes are stored in a memory so the program codes executed by the controller later. Alternatively, in an embodiment, various functions of the controller may be implemented as one or more circuits. The invention is not intended to limit whether various functions of the controller are implemented by ways of software or hardware.

In summary, according to the smart glasses expanding eye box provided by the embodiments of the invention, the adjustable liquid crystal panel is used to make the phase retardation of the image beam adjustable and accordingly make the polarization direction of the image beam adjustable. Further, in combination with the birefringent crystal plate, the projection position of the image beam can be adjusted to achieve the function of expanding eye box.

1. Smart glasses having expanding eyebox, comprising:
a projector, configured to provide an image beam, which is polarized; and
at least one beam translation module, disposed on a path of the image beam, and comprising:
an adjustable liquid crystal panel, disposed on the path of the image beam, and configured to adjust an amount of phase retardation of the image beam, wherein the image beam emitted in different directions is perpendicularly incident on different positions of the adjustable liquid crystal panel; and
a birefringent crystal plate, disposed on a path of the image beam from the adjustable liquid crystal panel, wherein after the amount of phase retardation of the image beam is adjusted through the adjustable liquid crystal panel, a translation in a direction parallel to a beam-emitting surface of the birefringent crystal plate occurs on the image beam exited from the birefringent crystal plate, and wherein the image beam emitted in different directions is perpendicularly incident on different positions of the birefringent crystal plate,
wherein the image beam is perpendicularly incident on a surface of the birefringent crystal plate, and the surface is an arc-shaped surface.

2. The smart glasses having expanding eyebox of claim 1, wherein an optical axis of crystal of the birefringent crystal plate is inclined at an angle with respect to an incident direction of the image beam incident on the birefringent crystal plate.

3. The smart glasses having expanding eyebox of claim 1, wherein the image beam is perpendicularly incident on a surface of the adjustable liquid crystal panel, and the surface is an arc-shaped surface.

4. (canceled)

5. The smart glasses having expanding eyebox of claim 1, wherein the projector comprises:
an image source, configured to emit an original image beam; and
a polarizer, disposed on a path of the original image beam to convert the original image beam into the image beam, which is polarized.

6. The smart glasses having expanding eyebox of claim 5, wherein the original image beam is perpendicularly incident on the polarizer, and the polarizer is an arc-shaped polarizer.

7. The smart glasses having expanding eyebox of claim 5, wherein the image source comprises a plurality of laser diodes.

8. The smart glasses having expanding eyebox of claim 5, wherein the image source comprises a red laser diode, a green laser diode, and a blue laser diode.

9. The smart glasses having expanding eyebox of claim 8, wherein the image source further comprises a plurality of beam splitters disposed on paths of a red laser light emitted by the red laser diode, a green laser light emitted by the green laser diode, and a blue laser light emitted by the blue laser diode, respectively.

10. The smart glasses having expanding eyebox of claim 9, wherein the beam splitters are configured to combine the red laser light, the green laser light, and the blue laser light into the original image beam.

11. The smart glasses having expanding eyebox of claim 10, wherein the image source further comprises a scanning mirror disposed on the path of the original image beam from the beam splitters to reflect the original image beam in different directions.

12. The smart glasses having expanding eyebox of claim 1, further comprising:
a lens, disposed on a path of the image beam from the beam translation module, and configured to transmit the image beam to an eye of a user; and
a diffraction optical element, disposed on the lens, and configured to transmit the image beam to the eye.

13. The smart glasses having expanding eyebox of claim 1, further comprising a lens, disposed between the projector and the adjustable liquid crystal panel.

14. The smart glasses having expanding eyebox of claim 1, further comprising a controller, electrically connected to the adjustable liquid crystal panel, and configured to control operations of the adjustable liquid crystal panel to accordingly control the translation of the image beam.

15. The smart glasses having expanding eyebox of claim 1, wherein the at least one beam translation module is a plurality of beam translation modules, sequentially arranged on a path of the image beam from the projector.
